(19) United States
(12) Patent Application Publication
(10) Pub. No.: US 2025/0380188 A1
(43) Pub. Date: Dec. 11, 2025

(54) DYNAMICALLY ADJUSTING AN APPLICATION DEMAND PROFILE DURING SLICE FALLBACK

(71) Applicant: T-MOBILE INNOVATIONS LLC, Overland Park, KS (US)

(72) Inventors: Michael Aaron ROBERTS, Spring Hill, KS (US); Tejaswini Shivabasanagouda PATIL, Herndon, VA (US); Sharath SOMASHEKAR, Overland Park, KS (US)

(21) Appl. No.: 18/736,066

(22) Filed: Jun. 6, 2024

(51) Int. Cl. H04W 28/06; H04W 8/22; H04W 76/19

(52) U.S. Cl. CPC H04W 28/06; H04W 8/22; H04W 76/19

(57) ABSTRACT

Systems and methods for dynamically adjusting an application demand profile during slice fallback are provided. In some aspects, an attribute quality table for an application of a UE may be received. The attribute quality table determines a demand profile for the application on a 5G SA network. A network slice may be allocated based on the demand profile. When the UE falls back from the 5G SA network to a 5G NSA network or an LTE network, a negotiation utilizing the attribute quality table, current RF conditions, and the QoS capabilities of the 5G NSA network or the EPC of the LTE network determines an optimal combination of network resources that provides the highest quality user experience. In some aspects, the application adjusts, in real-time, the demand profile that best meets the available resources of the 5G NSA network or the EPC of the LTE network.

### BACKGROUND

A 5G network slice is a telecommunications network configuration that establishes multiple independent virtualized networks on the common physical infrastructure of a 5G network operator core. For each network slice instance, associated network functions can be orchestrated as needed to support the specific needs and/or use case of the customer using the network slice. Network resources allocated to a network slice may be tailored to customize parameters such as bandwidth, speed, and latency. A network slice may be established for a customer by the 5G network operator as a service that essentially provides the customer with a private end-to-end networking solution that includes complete logical isolation from other slices operating on the same physical infrastructure elements of the 5G network operator core and through common access networks (e.g., radio access networks).

Applications on 5G Standalone (SA) devices are developed to be elastic and can function at different quality levels depending on the radio frequency (RF) conditions and available network resources. To do so, applications determine a demand profile in an attempt to achieve an optimal user experience. Network slicing is a 5G Standalone (SA) core feature that is not backwards compatible to 5G Non-Standalone (NSA) or Long Term Evolution (LTE) evolved packet core (EPC). If a user device (UE) of the customer is connected to 5G SA and utilizing a network slice and the device steps down to 5G NSA or falls back to LTE, the network slice is dropped. In this scenario, there are no longer any policies in place to ensure the quality of the data session as the network provides only a best-effort delivery of its services. An application may downgrade various parameters of its demand profile to keep it functioning, but a negative impact may be experienced by the customer.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

One or more of the aspects presented in the disclosure provide for, among other things, systems and methods for dynamically adjusting an application demand profile during slice fallback. One or more of the aspects disclosed herein introduce a technology through which an application executing on a UE can dynamically adjust an application demand profile during slice fallback. In some aspects, an attribute quality table for an application of a UE may be received. The attribute quality table determines a demand profile for the application on a 5G SA network. A network slice may be allocated based on the demand profile. When the UE falls back from the 5G SA network to a 5G NSA network or an LTE network, a negotiation utilizing the attribute quality table, current RF conditions, and the QoS capabilities of the 5G NSA network or the EPC of the LTE network determines an optimal combination of network resources that provides the highest quality user experience. In some aspects, the application adjusts, in real-time, the demand profile that best meets the available resources of the 5G NSA network or the EPC of the LTE network.

### BRIEF DESCRIPTION OF THE DRAWINGS

Aspects of the present disclosure are described in detail herein with reference to the attached Figures, which are intended to be exemplary and non-limiting, wherein:

FIG. 1 is a diagram illustrating an example network environment for a telecommunications network, in accordance with some aspects described herein;

FIG. 2 is a diagram illustrating an example slice fallback engine for application adjusted demand profile for slice fallback, in accordance with some aspects described herein;

FIG. 3 is a flow chart illustrating an example method for dynamic slice fallback in accordance with some aspects described herein;

FIG. 4 is an example computing device, in accordance with some aspects described herein.

### DETAILED DESCRIPTION

The subject matter of aspects of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of aspects described in the present disclosure. The following is a list of these acronyms:
3G Third-Generation Wireless Technology
4G Fourth-Generation Cellular Communication System
5G Fifth-Generation Cellular Communication System
6G Sixth-Generation Cellular Communication System
AI Artificial Intelligence
CD-ROM Compact Disk Read Only Memory
CDMA Code Division Multiple Access
eNodeB Evolved Node B
GIS Geographic/Geographical/Geospatial Information System
gNodeB Next Generation Node B
GPRS General Packet Radio Service
GSM Global System for Mobile communications
iDEN Integrated Digital Enhanced Network
DVD Digital Versatile Discs
EEPROM Electrically Erasable Programmable Read Only Memory
LED Light Emitting Diode
LTE Long Term Evolution
MIMO Multiple Input Multiple Output
MD Mobile Device
ML Machine Learning
PC Personal Computer
PCS Personal Communications Service
PDA Personal Digital Assistant
PDSCH Physical Downlink Shared Channel
PHICH Physical Hybrid ARQ Indicator Channel
PUCCH Physical Uplink Control Channel
PUSCH Physical Uplink Shared Channel
RAM Random Access Memory
RET Remote Electrical Tilt
RF Radio-Frequency
RFI Radio-Frequency Interference
R/N Relay Node
RNR Reverse Noise Rise
ROM Read Only Memory
RSRP Reference Signal Receive Power
RSRQ Reference Signal Receive Quality
RSSI Received Signal Strength Indicator
SINR Transmission-to-Interference-Plus-Noise Ratio
SNR Transmission-to-noise ratio
SON Self-Organizing Networks
TDMA Time Division Multiple Access
TXRU Transceiver (or Transceiver Unit)
UE User Equipment
UMTS Universal Mobile Telecommunications Systems
WCD Wireless Communication Device (interchangeable with UE)

Further, various technical terms are used throughout this description. An illustrative resource that fleshes out various aspects of these terms can be found in Newton's Telecom Dictionary, 32^{nd} Edition (2022).

Currently a UE operating on a cellular network, such as a 5G stand-alone (SA) network, may be configured to operate on one or more network slices based on Quality-of-Service (QOS) specifications for an application or the type of network traffic associated with the application, such as with respect to network latency, bandwidth, data rates, and/or reliability, for example. When an application is executed, a slice for the application may be selected based on a policy associated with the application. If the UE already has an established slice appropriate for the application per the policy, the application may establish connectivity via the telecommunications network over that slice. If the UE does not have an established slice appropriate for the application per the policy, the UE may trigger instantiation of a new network slice connection appropriate for the application per the policy.

Once a network slice is allocated to an application, the application remains on that network slice until execution of the application is terminated. However, the characteristics of network traffic used by an application may vary over time and/or be based on how the application is being used. If a network slice is allocated to an application based on its highest QoS level, such as a peak bandwidth and/or low-latency criteria, then that network slice may represent an over-allocation of network resources to the application at times where the application is operating in a mode that is not utilizing high-bandwidth and/or low-latency traffic. For example, the UE may be executing an application that receives network traffic from the telecommunications network that includes low-bandwidth textual and/or still frame image content during some periods, and high-bandwidth video streaming at other periods. An example of such an application may be an application for a video streaming service. When the application is presenting a high-definition video stream on the UE (e.g., a 4K video stream), then a network slice supporting a high level of data packet throughput may be allocated to support the high-definition video streaming traffic. However, when a user is instead just using the application for low-bandwidth tasks, such as to browse a catalog of available streaming content, or has the application otherwise idle (e.g., running in the background), then that initial network slice capable of supporting high-definition video stream is unnecessarily reserving and/or allocating finite network resources that are inefficiently in excess of what is adequate to support the application at that time.

Moreover, if a UE of is connected to 5G SA and utilizing a network slice and the device steps down to 5G NSA or falls back to LTE, the network slice is dropped. Since there are no longer any policies in place to ensure the quality of the data session, the network provides only a best-efforts delivery of its services. Accordingly, an application may downgrade various parameters of its demand profile to keep it functioning, but a negative impact may be experienced by the customer.

As discussed in greater detail herein, some aspects of this disclosure, among other things, better optimize the use of network resources—while maintaining a quality user experience—by dynamically adjusting an application demand profile during slice fallback (or based on a change in an attribute quality table). In some aspects, an attribute quality table is received for an application of a UE. The attribute quality table determines a demand profile for the application. A network slice may be allocated based on the demand profile. When the UE falls back from the 5G SA network to a 5G NSA network or an LTE network, a negotiation utilizing the attribute quality table, current RF conditions, and the QoS capabilities of the 5G NSA network or the EPC of the LTE network determines an optimal combination of network resources that provides the highest quality user experience. In some aspects, the application adjusts, in real-time, the demand profile that best meets the available resources of the 5G NSA network or the EPC of the LTE network.

In a first aspect of the present invention, computer-readable media is provided, the computer-readable media having computer-executable instructions embodied thereon that, when executed, perform a method of dynamically adjusting an application demand profile during slice fallback. The method comprises, based on a user equipment (UE) fallback, receiving an attribute quality table for an application of the UE. The method also comprises, based on the attribute quality table, radio frequency (RF) conditions, and quality of service (QOS) capabilities, optimizing capabilities for the data connection.

A second aspect of the present disclosure is directed to a method of dynamically adjusting an application demand profile during slice fallback. The method comprises, based on a user equipment (UE) fallback, receiving an attribute quality table for an application of the UE. The method also comprises, based on the attribute quality table, radio frequency (RF) conditions, and quality of service (QOS) capabilities, optimizing capabilities for the data connection.

Another aspect of the present disclosure is directed to a system for dynamically adjusting an application demand profile during slice fallback. The system comprises: at least one wireless base station coupled to an operator core network, wherein the at least one wireless base station establishes one or more communication links between the operator core network and a user equipment (UE); and one or more processors to perform one or more operations. The operations comprise, based on a user equipment (UE) fallback, receiving an attribute quality table for an application of the UE. The operations also comprise, based on the attribute quality table, radio frequency (RF) conditions, and quality of service (QOS) capabilities, optimizing capabilities for the data connection.

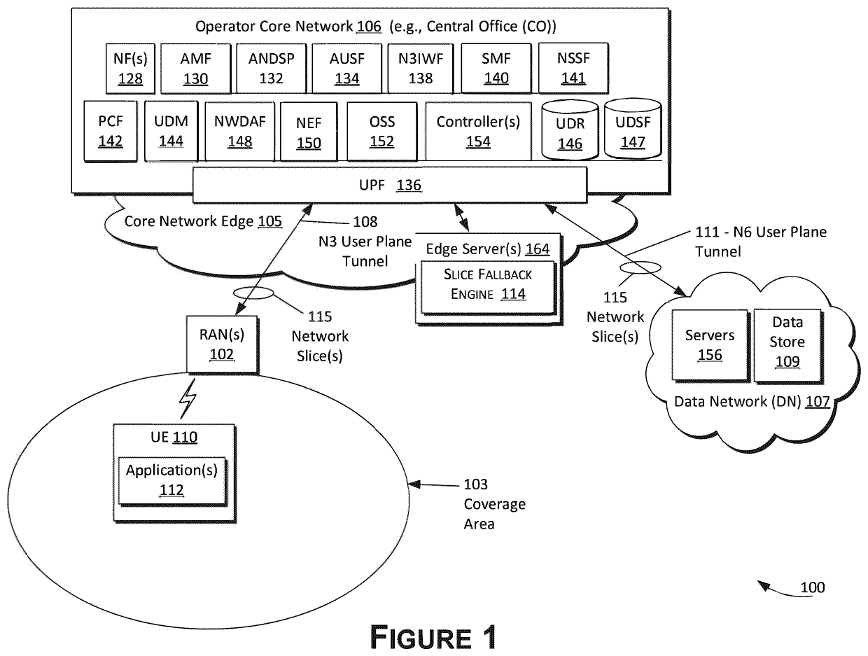

FIG. 1 is a diagram illustrating an example network environment 100 for a wireless communication system. Network environment 100 is but one example of a suitable telecommunications network and is not intended to suggest any limitation as to the scope of use or functionality of the aspects disclosed herein, and nor should the network environment be interpreted as having any dependency or requirement relating to any one or combination of components illustrated.

As shown in FIG. 1, network environment 100 comprises an operator core network 106 (also referred to as a “core network”) that provides one or more network services to one or more UEs 110 (e.g., 3GPP UE) via at least one access network, such as radio access network (RAN) 102. In some aspects, network environment 100 comprises, at least in part, a wireless communications network, such as, but not limited to, a 5G wireless communications network.

In some aspects, the network environment 100 comprises one or more radio access networks (RANs) 102, which may be referred to in the context of a wireless telecommunications network as a wireless base station, cell site, or cellular base station. A RAN 102 may represent at least one wireless base station coupled to an operator core network to establish one or more communication links between the operator core network 106 and a user equipment (UE) 110. Each RAN may provide wireless connectivity access to one or more UEs operating within a coverage area 103 associated with that RAN 102. The RAN 102 may implement wireless connectivity using, for example, 3GPP technologies. The RAN 102 may be referred to as an eNodeB in the context of a 4G Long-Term Evolution (LTE) implementation, a gNodeB in the context of a 5G New Radio (NR) implementation, or other terminology depending on the specific implementation technology. In some aspects, the RAN 102 may comprise, at least in part, components of a customer premises network, such as a distributed antenna system (DAS), for example.

Radio access network(s) 102 may comprise a multimodal network (for example, comprising one or more multimodal access devices) where multiple radios supporting different systems are integrated into the radio access network(s) 102. Such a multimodal access network may support a combination of 3GPP radio technologies (e.g., 4G, 5G, and/or 6G) and/or non-3GPP radio technologies (e.g., IEEE 802.11 (WiFi) and/or IEEE 802.15 (Bluetooth) access points). In some aspects, the radio access network(s) 102 may comprise a terrestrial wireless communications base station and/or may be at least in part implemented as a space-based access network, such as a base station implemented by an Earth-orbiting satellite. Individual UE 110 may communicate with the operator core network 106 via the RAN 102 over one or both of uplink (UL) radio frequency (RF) signals and downlink (DL) radio frequency (RF) signals.

The radio access network(s) 102 may be coupled to the operator core network 106 via a core network edge 105 that comprises edge server nodes and wired and/or wireless network connections that may further include wireless relays and/or repeaters. In some aspects, the RAN 102 may be coupled to the operator core network 106 at least in part by a backhaul network such as the Internet or other public or private network infrastructure. Core network edge 105 may comprise one or more network nodes (e.g., servers) or other elements of the operator core network 106 that may define the boundary of the operator core network 106 and may serve as the architectural demarcation point where the operator core network 106 connects to other networks such as, but not limited to, RAN 102, the Internet, Data Network (DN) 107, and/or other third-party networks. In some aspects, the network edge 105 may comprise one or more network nodes that include edge server(s) 164. Edge server(s) 164 may provide, for example, edge-based services to UE 110 that may be accessed separately from services provided by network functions of the operator core network 106. For example, edge server(s) 164 may host databases, caches, microservices, ledgers, decentralized applications (e.g., DApps), and/or may perform data traffic monitoring, inspections, and/or aggregation for other network functions of the network environment 100.

It should be understood that in some aspects, the network environment 100 may not comprise a distinct operator core network 106, but rather may implement one or more features of the operator core network 106 within other portions of the network, or may not implement them at all, depending on various carrier preferences.

As shown in FIG. 1, network environment 100 may also comprise at least one data network (DN) 107 coupled to the operator core network 106 (e.g., via the network edge 105). Data network 107 may include one or more data stores 109 and/or one or more content-services servers 156. In some aspects, UE 110 may access services and/or content provided by the data store(s) 109 and/or server(s) 156 of DN 107.

Generally, an individual UE 110 may comprise a device capable of unidirectional or bidirectional communication with the operator core network 106 via wireless and/or wired communication links. The network environment 100 may be configured for wirelessly connecting UEs 110 to other UEs 110 via the same access networks (e.g., RANs 102), via other access networks, via other telecommunications networks, and/or to connect UEs 110 to a public switched telecommunications network (PSTN). The network environment 100 may be generally configured, in some aspects, for connecting UE 110 to data, content, and/or services that may be accessible from one or more application servers or other functions, nodes, or servers. In allocating network resources and access to these data or services, the operator core network 106 may instantiate one or more network slices 115 and allocate one or more of those slice(s) 115 to carry network traffic for one or more applications 112 executed by processors of the UE 110. Within the context of the network slice(s) 115 as described herein, an application and/or a UE 110 may function in the capacity of a subject entity that requests data and/or services from other networked elements (e.g., network functions and/or elements of DN 107) via network slice(s) 115 and/or a resource entity that provides data and/or services to other networked elements (e.g., network functions and/or elements of DN 107) via network slice(s) 115.

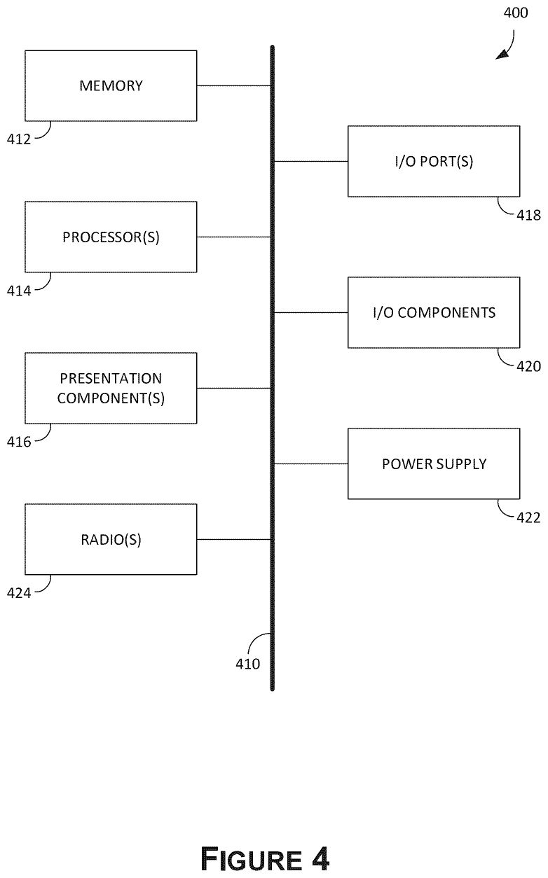

UEs 110 are in general forms of equipment and machines such as, but not limited to, Internet-of-Things (IoT) devices and smart appliances, autonomous or semi-autonomous vehicles including cars, trucks, trains, aircraft, urban air mobility (UAM) vehicles and/or drones, industrial machinery, robotic devices, exoskeletons, manufacturing tooling, thermostats, locks, smart speakers, lighting devices, smart receptacles, controllers, mechanical actuators, remote sensors, weather or other environmental sensors, wireless beacons, cash registers, turnstiles, security gates, or any other smart device. That said, in some aspects, UE 110 may include computing devices such as, but not limited to, handheld personal computing devices, cellular phones, smart phones, tablets, laptops, and similar consumer equipment, or stationary desktop computing devices, workstations, servers, and/or network infrastructure equipment. As such, the UE 110 may include both mobile UE and stationary UE. A UE 110 can include one or more processors and one or more non-transient computer-readable media for executing code to carry out the functions of the UE 110 described herein, including one or more aspects of a slice fallback engine 114 discussed herein. The computer-readable media may include computer-readable instructions executable by the one or more processors. In some aspects, the UE 110 may be implemented using a computing device 400, as discussed below with respect to FIG. 4.

In some implementations, the operator core network 106 may comprise modules, also referred to as network functions (NFs), implemented by one or more processors and generally represented in FIG. 1 as NF(s) 128. Individual network functions that are distinctly illustrated in FIG. 1 may include, but are not limited to, one or more of a core access and mobility management function (AMF) 130, an access network discovery and selection policy (ANDSP) 132, an authentication server function (AUSF) 134, a user plane function (UPF) 136, non-3GPP interworking function (N3IWF) 138, a session management function (SMF) 140, a network slice selection function (NSSF) 141, a policy control function (PCF) 142, unified data management (UDM) 144, a unified data repository (UDR) 146, an unstructured data storage function (UDSF) 147, a network data analytics function (NWDAF) 148, a network exposure function (NEF) 150, and an operations support system (OSS) 152. Implementation of these NFs of the operator core network 106 may be executed by one or more controllers 154 on which these network functions are orchestrated or otherwise configured to execute utilizing processors and memory of the one or more controllers 154. The NFs may be implemented as physical and/or virtual network functions, container network functions, and/or cloud-native network functions, such as is described with respect to FIG. 6. Within the context of network slice(s) 115 created by the operator core network 106, the operator core network 106 may orchestrate individual dedicated instances of one or more of the network functions described herein to establish and support operation of a network slice 115.

Notably, the nomenclature used herein is used primarily with respect to the 3GPP 5G architecture. In other aspects, one or more of the network functions of the operator core network 106 may take different forms, including consolidated or distributed forms that perform the same general operations. For example, the AMF 130 in the 3GPP 5G architecture is configured for various functions relating to security and access management and authorization, including registration management, connection management, paging, and mobility management. In other forms, such as a 4G architecture, the AMF 130 of FIG. 1 may take the form of a mobility management entity (MME). The operator core network 106 may be generally said to authorize rights to and facilitate access to an application server/service, such as provided by application function(s) requested by one or more UEs, such as UE 110. In some aspects, the NSSF 141 works in conjunction with the AMF 130 to establish network slice instances of network slice(s) 115, such as is described herein.

As shown in FIG. 1, UPF 136 represents at least one function of the operator core network 106 that may extend into the core network edge 105. In some aspects, the RAN 102 is coupled to the UPF 136 within the core network edge 105 by a communication link that includes an N3 user plane tunnel 108. For example, the N3 user plane tunnel 108 may connect a cell site router of the RAN 102 to an N3 interface of the UPF 136. The data store(s) 109, server(s) 156, and/or other elements of DN 107 may be coupled to the UPF 136 in the core network edge 105 by an N6 user plane tunnel 111. For example, the N6 user plane tunnel 111 may connect a network interface (e.g., a switch, router, and/or gateway) of the DN 107 to an N6 interface of the UPF 136. In some aspects, the operator core network 106 may comprise a plurality of UPFs 136, such as a UPF at the operator core network 106 and a UPF at the core network edge 105. For example, a UPF at the core network edge 105 may be used for local breakout and/or low-latency types of application via an N9 interface between the distinct UPFs.

The AMF 130 facilitates mobility management, registration management, and connection management for 3GPP devices, such as a UE 110. ANDSP 132 facilitates mobility management, registration management, and connection management for non-3GPP devices (e.g., devices that connect via the N3IWF 138). AUSF 134 may receive authentication requests from the AMF 130 and interacts with UDM 144, for example, for subscriber identification module (SIM) authentication and/or to authenticate a UE 110 based on a device identification (ID). N3IWF 138 provides a secure gateway for non-3GPP network access, which may be used for providing connections for UE 110 access to the operator core network 106 over a non-3GPP access network (e.g., via a data link established between a customer premise gateway 161 and the N3IWF 138).

In some aspects, the PCF 142 maintains subscription information indicating one or more services and/or microservices subscribed to by each UE 110. In some aspects, a PCF 142 instance may maintain subscription information pertaining to UE 110 authorized to access services from within a network slice 115. The UDM 144 manages network user data including, but not limited to, data storage management, subscription management, policy control, and core network 106 exposure. NWDAF 148 collects data (for example, from UE; other network functions; application functions; and operations, administration, and maintenance (OAM) systems) that can be used for network data analytics. The OSS 152 is responsible for the management and orchestration of one or more elements of the operator core network 106 and the various physical, virtual network functions, container network functions, controllers, computer nodes, and other elements that implement the operator core network 106.

Some aspects of network environment 100 include the UDR 146 storing information relating to access control and service and/or microservice subscriptions. The UDR 146 may be configured to store information relating to such subscriber information and may be accessible by multiple different network functions (NFs) 128 in order to perform desirable functions. For example, the UDR 146 may be accessed by the AMF 130 in order to determine subscriber information pertaining to the UE 110 (e.g., which network slices the UE 110 is subscribed to use), accessed by a PCF 142 to obtain policy-related data, and/or accessed by NEF 150 to obtain data that is permitted for exposure to third-party applications (such as applications 112 executed by UE 110, for example). Other functions of the NEF 150 include monitoring of UE-related events and posting information about those events for use by external entities, and providing an interface for provisioning UEs 110 (e.g., via PCF 142) and reporting provisioning events to the UDR 146. Although depicted as a unified data management module, UDR 146 can be implemented as a plurality of network function specific data management modules. As mentioned above, in the context of a network slice 115, the operator core network 106 may orchestrate individual instances of each of these network functions and other such network functions described herein that are dedicated to the network slice 115.

The UPF 136 is generally configured to facilitate user plane operation relating to packet routing and forwarding, interconnection to a data network (e.g., DN 107), policy enforcement, and data buffering, among other operations. Using network slicing (e.g., based on 5G software-defined networking managed by the 5G network slice selection function (NSSF) 141), the UPF 136 may establish a dedicated slice network function for one or more data channels between various network functions and other entities that act as, in essence, a distinct network (for example, establishing its own QoS, provisioning, and/or security) within the same physical network architecture of network environment 100. As explained herein, the NSSF 141, either alone or in conjunction with other network functions of the operator core network 106, may function as a slice coordination network function to control the operator core network 106 to orchestrate individual dedicated instances of one or more of the network functions described herein to establish and support operation of network slices allocated to application(s) of the UE 110 based on network slice allocation requests (i.e., demand profile) from the application(s) executing on the UE 110, as defined by an attribute quality table(s) received from the application(s). A network slice type may be used to identify service characteristics of a network slice 115, and at least in part may define the configuration of the slice network functions that make up that network slice. For example, in different implementations, a UE 110 may be assigned a network slice 115 (e.g., for use by application(s) 112), such as an Enhanced Mobile Broadband (eMBB) network slice, a Massive Machine Type Communications (MMTC) network slice, an Ultra-Reliable Low-Latency Communication (URLLC) network slice, or a Public Safety (PS) network slice. A network slice instance, therefore, may comprise an instantiation of a specific network slice type. During slice fallback, slice fallback engine 114 dynamically adjusts the application demand profile to optimize capabilities for the data connection and avoid a scenario where the application receives only best efforts from the network. Slice fallback engine 114 may be implemented at least in part by network nodes of the UPF 136.

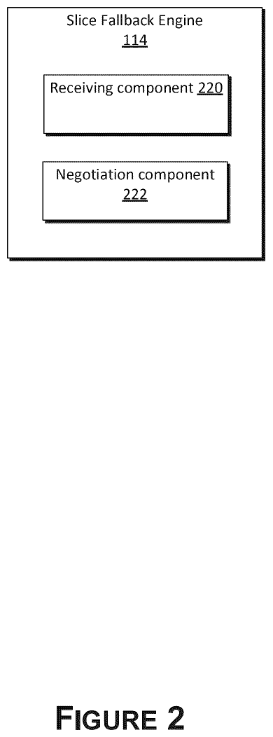

As shown in FIG. 2, in some aspects, a slice fallback engine 114 may include a receiving component 220 and a negotiation component 222. Although illustrated as distinct elements of the slice fallback engine 114, one or more of the receiving component 220 and the negotiation component 222 may be integrated together and/or their functions implemented at least in part by other elements of the operator core network 106 and/or core network edge 105.

In some aspects, when UE 110 network connectivity is initialized with the operator core network 106, the NSSF 141 (e.g., based on subscription information from the PCF 142) may identify a set of available network slices that may potentially be allocated to the UE 110 and/or an application 112 executing on the UE 110. An indication of this set of available network slices for a UE 110 and/or an application 112 executing on the UE 110 may be provided as available slice data 222. The available slice data may thus represent the set of available network slices that the operator core network 106 has determined that the UE 110 and/or an application 112 executing on the UE 110 is able to use and authorized as available for potential allocation to the UE 110 (e.g., based on that UE 110's applicable capabilities and subscription(s)) and/or an application 112 executing on the UE 110 (based on an attribute quality table of the application 112 that determines the demand profile).

Initially, an attribute quality table of the application 112 may be received by receiving component 220 of the slice fallback engine 114. An example of an attribute quality table may include attributes: bitrate, codec, resolution, framerate, packet loss, jitter, and/or latency and can apply to both audio and video and content sharing. The attribute quality table may be used to determine the demand profile of the application. Once the attribute quality table is received, a negotiation between the application 112 and the network as may determine which of the network slices indicated as available by the available slice data is most optimally suited for the application 112—and trigger the UE 110 and/or the application 112 to request an allocation of that network slice to UE 110 for use by the application 112. That is, once the attribute quality table is received and determines the demand profile of the application, the negotiation component 222 may initiate a negotiation between the UE 110 and/or the application 112 and the network to determine which network slice the UE 110 and/or the application 112 should request.

A definition map or table that correlates such network traffic characteristics identified in the attribute quality table with different candidate network slices may be referenced by negotiation component 222 as part of the negotiation. Network slices that match the network traffic characteristics identified in the attribute quality table can then be selected from the available slice data. In some aspects, a trigger message may be sent, for example, by negotiation component 222 to a network management function of the operating system of the UE 110 to cause the UE 110 and/or the application 112 to request an allocation of a network slice from the operator core network 106.

In response to the trigger message, the UE 110 may transmit to the operator core network 106 (e.g., the NSSF 141) a slice allocation request comprising a slice identifier (e.g., a PDU session modification request) that includes an indication of a network slice (e.g., a slice identifier associated with the selected network slice). In some aspects, the slice allocation request may further include an application ID for the application 112 associated with the selected network slice. The operator core network 106 may then respond to the slice allocation request by allocating the requested network slice to the UE 110 for use by the application 112 and/or otherwise instantiating an instance of the requested network slice.

In some aspects, instantiating the requested network slice may further include the operator core network 106 (e.g., the NSSF 141) deallocating and/or dismantling the instance of the initial network slice that is being replaced by the requested network slice. The operator core network 106 may first instantiate the requested network slice and transfer the application 112 over to the new network slice instance before deallocating the initial network slice so that the application 112 does not experience a substantive interruption of network connectivity and/or network traffic. That is, the application 112 may remain running on the UE 110 with an active PDU session (e.g., with data store(s) 109 and/or content server(s) 156) during the network slice transfer from the first (e.g., initial) network slice to the second (e.g., requested) network slice. Increased network efficiency is realized by optimally matching an application 112 operating mode to a network slice, while avoiding restarting and/or initializing the application 112 with the operator core network 106.

In some aspects, as use of the application 114 (such as changing from video to voice) may cause the attribute quality table to change. Accordingly, the demand profile may change in real-time as use, features, or characteristics of the application 112 changes. For example, an application 112 that has a routing selection policy that routes traffic to a server 156 for a known video streaming service may be allocated an initial network slice allocation configuration that supports high-bandwidth network traffic. The demand profile may change when the application 112 has shifted to an operation mode that does not involve communicating high-bandwidth network traffic (e.g., catalog browsing) and, negotiation component 222 may cause the UE 110 and/or the application 112 to request a lower bandwidth slice allocation configuration for the UE 110 and/or the application 112, as described herein. When the application 112 shifts back to the high-bandwidth network traffic operating mode, the receiving component 220 may receive the demand profile as dynamically updated by the attribute quality table and the negotiation component 222 may cause the UE 110 and/or the application 112 to reselect the higher bandwidth slice allocation configuration for the UE 110 and/or the application 112. The NSSF 141 may respond to such network slice allocation requests from the UE 110 and/or the application 112 to allocate and/or deallocate access to network slices 115 dynamically in response to requests triggered by the slice fallback engine 114.

The slice fallback engine 114 thus benefits both the operation of the UE 110, the application 112, and/or the operator core network 106 by optimally facilitating the network slice allocations for the application 112—providing high-level network slice(s) 115 for some operating modes, and lower level network slice(s) 115 for other operating modes, to more efficiently allocate network resources while continuing to run the application 112 on the UE 110 without interruption. In some aspects, the slice fallback engine 114 itself may be executed as a background process. The slice fallback engine 114 may periodically or continuously receive the attribute quality table to determine when an application 112 switches to an operating mode warranting a change in its network slice allocation. For example, the slice fallback engine 114 may monitor the attribute quality table and determine if there are any changes in an application's network utilization that may necessitate the UE 110 and/or the application 112 to select a new slice allocation based on the changes crossing a threshold.

In some aspects, the slice fallback engine 114 helps the UE 110 and/or the application 112 maintain a certain quality if the UE is connected to a 5G SA network slice and the device steps down to 5G NSA or falls back to LTE. In this example, the network slice will be dropped. Because the receiving component 220 of the slice fallback engine 114 receives the attribute quality table for the application, the slice fallback engine 114 is able to ensure the quality of the data session. The negotiation component initially establishes a data connection with the 5G NSA network and/or the LTE network with an elevated priority and quality of service in order to keep the user experience as high as possible. The negotiation component 222 includes the attribute quality table, the current RF conditions (e.g., RSRP, SINR, etc.), and the quality of service capabilities of the EPC (e.g., priority routing) to determine the optimal combination that provides the highest quality user experience. As a result, the application 112 dynamically updates its demand profile that best matches the EPC and RAN capabilities, in real-time. If the UE reconnects to the 5G SA network, the UE 110 and/or the application 112 may again request a network slice, as described herein.

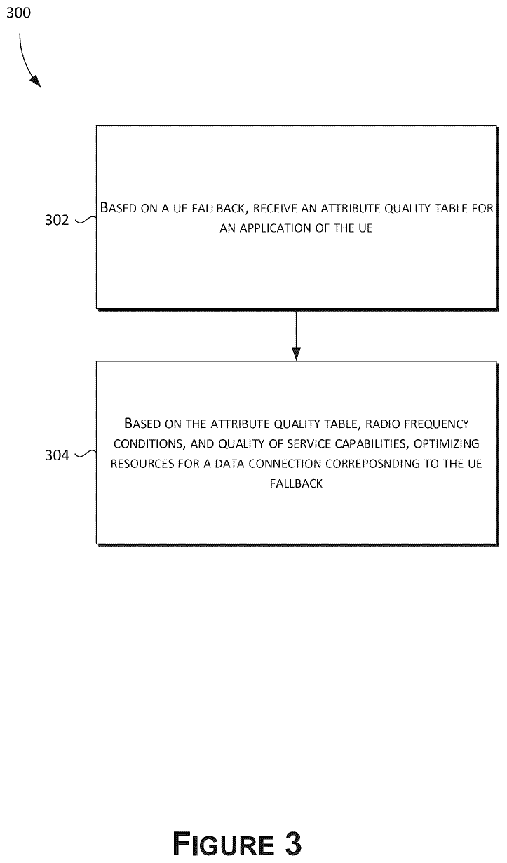

FIG. 3 is a flow chart illustrating a method 400 for dynamically adjusting an application demand profile during slice fallback, according to some aspects. It should be understood that the features and elements described herein with respect to the method of FIG. 3 may be used in conjunction with, in combination with, or substituted for elements of any of the other aspects discussed herein and vice versa. Further, it should be understood that the functions, structures, and other descriptions of elements for aspects described in FIG. 3 may apply to like or similarly named or described elements across any of the figures and/or aspects described herein and vice versa. In some aspects, elements of method 400 are implemented utilizing one or more processing units, such as the controller of an operator core network, an edge server, a RAN, a UE, and/or other processing units, as disclosed in any of the aspects herein. In some aspects, the method 300 may be implemented by components of a telecommunications network environment 100, such as illustrated by FIG. 1. In some aspects, the method may be performed at least in part by a slice fallback engine, such as the slice fallback engine 114 discussed above with respect to FIGS. 1 and 2.

Initially, at 302, based on UE fallback, an attribute quality table is received for an application of the UE. In some aspects, the attribute quality table determines the demand profile for the application. Attributes defined by the attribute quality table may include one or more of: bitrate, codec, resolution, framerate, packet loss, jitter, or latency. In some aspects, the UE fallback is imitated from a 5G SA network to a 5G NSA network. In other aspects, the UE fallback is imitated from a 5G SA network to an EPC of an LTE network.

At 304, based on the attribute quality table, radio frequency (RF) conditions, and quality of service (QOS) capabilities, capabilities for the data connection are optimized. To do so, the slice fallback engine considers the attribute quality table, RF conditions, and QoS capabilities to determine the best fit for the application based on current network conditions of the 5G NSA network or the EPC of the LTE network. Based on this determination, the demand profile for the application is adjusted in real-time. Accordingly, the application avoids a best efforts treatment by the available network and instead receives the highest quality user experience that corresponds to the attribute quality table and is available at that time.

Referring to FIG. 4, a diagram is depicted of an exemplary computing environment suitable for use in implementations of the present disclosure. In particular, the exemplary computer environment is shown and designated generally as computing device 400. Computing device 400 is but one example of a suitable computing environment and is not intended to suggest any limitation as to the scope of use or functionality of the aspects described herein, and nor should computing device 400 be interpreted as having any dependency or requirement relating to any one or combination of components illustrated.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 4, computing device 400 includes bus 410 that directly or indirectly couples the following devices: memory 412, one or more processors 414, one or more presentation components 416, input/output (I/O) ports 418, I/O components 420, power supply 422, and radio 424. Bus 410 represents what may be one or more buses (such as an address bus, data bus, or combination thereof). The devices of FIG. 4 are shown with lines for the sake of clarity. However, it should be understood that the functions performed by one or more components of the computing device 400 may be combined or distributed amongst the various components. For example, a presentation component such as a display device may be one of I/O components 420. In some aspects, one or more functions of a slice fallback engine 114 discussed herein may be executed at least in part by computing device 400. The processors 414 of computing device 400 may include a memory. The present disclosure hereof recognizes that such is the nature of the art, and reiterates that FIG. 4 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 4 and refer to “computer” or “computing device.”

Computing device 400 typically includes a variety of computer-readable media. For example, applications for UE 110 and/or slice fallback engine 114 may be stored in a memory comprising such computer-readable media. Computer-readable media can be any available media that can be accessed by computing device 400 and includes both volatile and non-volatile media, removable and non-removable media. By way of example, and not limitation, computer-readable media may comprise computer storage media and communication media. Computer storage media includes both volatile and non-volatile, removable and non-removable media implemented in any method or technology for storage of information such as computer-readable instructions, data structures, program modules, or other data.

Computer storage media includes non-transient RAM, ROM, EEPROM, flash memory or other memory technology, CD-ROM, digital versatile disks (DVDs) or other optical disk storage, magnetic cassettes, magnetic tape, magnetic disk storage, or other magnetic storage devices. Computer storage media and computer-readable media do not comprise a propagated data signal or signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 412 includes computer-storage media in the form of volatile and/or non-volatile memory. Memory 412 may be removable, non-removable, or a combination thereof. Exemplary memory includes solid-state memory, hard drives, optical-disc drives, etc. Computing device 400 includes one or more processors 414 that read data from various entities such as bus 410, memory 412, or I/O components 420. One or more presentation components 416 presents data indications to a person or other device. Exemplary one or more presentation components 416 include a display device, speaker, printing component, vibrating component, etc. I/O ports 418 allow computing device 400 to be logically coupled to other devices including I/O components 420, some of which may be built into computing device 400. Illustrative I/O components 420 include a microphone, joystick, game pad, satellite dish, scanner, printer, wireless device, etc.

Radio(s) 424 represents a radio that facilitates communication with a wireless telecommunications network. For example, radio(s) 424 may be used to establish communications with components of the RAN 102, operator core network 106, and/or core network edge 105. Illustrative wireless telecommunications technologies include CDMA, GPRS, TDMA, GSM, and the like. Radio(s) 424 may additionally or alternatively facilitate other types of wireless communications including Wi-Fi, WiMAX, LTE, and/or other VoIP communications. In some aspects, radio(s) 424 may support multimodal connections that include a combination of 3GPP radio technologies (e.g., 4G, 5G, and/or 6G) and/or non-3GPP radio technologies. As can be appreciated, in various aspects, radio(s) 424 can be configured to support multiple technologies and/or multiple radios can be utilized to support multiple technologies. In some aspects, the radio(s) 424 may support communicating with an access network comprising a terrestrial wireless communications base station and/or a space-based access network (e.g., an access network comprising a space-based wireless communications base station). A wireless telecommunications network might include an array of devices, which are not shown so as to not obscure more relevant aspects of the aspects described herein. Components such as a base station, a communications tower, or even access points (as well as other components) can provide wireless connectivity in some aspects.

In various alternative aspects, system and/or device elements, method steps, or example implementations described throughout this disclosure (such as the UE, access networks, core network edge, operator core network, network functions, slice fallback engine, slice coordination network function, and/or any of the sub-parts thereof, for example) may be implemented at least in part using one or more computer systems, field-programmable gate arrays (FPGAs), application-specific integrated circuits (ASICs), or similar devices comprising a processor coupled to a memory and executing code to realize that elements, processes, or examples, said code stored on a non-transient hardware data storage device. Therefore, other aspects of the present disclosure may include elements comprising program instructions resident on computer-readable media that when implemented by such computer systems, enable them to implement the aspects described herein. As used herein, the term “computer-readable media” refers to tangible memory storage devices having non-transient physical forms. Such non-transient physical forms may include computer memory devices, such as but not limited to: punch cards, magnetic disk or tape, any optical data storage system, flash read-only memory (ROM), non-volatile ROM, programmable ROM (PROM), erasable-programmable ROM (E-PROM), random-access memory (RAM), or any other form of permanent, semi-permanent, or temporary memory storage system of a device having a physical, tangible form. Program instructions include, but are not limited to, computer-executable instructions executed by computer system processors and hardware description languages such as Verilog or Very High Speed Integrated Circuit (VHSIC) Hardware Description Language (VHDL).

As used herein, the terms “network function,” “unit,” “server,” “node,” and “module” are used to describe computer processing components and/or one or more computer-executable services being executed on one or more computer processing components. In the context of this disclosure, such terms used in this manner would be understood by one skilled in the art to refer to specific network elements and not used as nonce word or intended to invoke 35 U.S.C. 112(f).

Many different arrangements of the various components depicted, as well as components not shown, are possible without departing from the scope of the claims below. Aspects in this disclosure are described with the intent to be illustrative rather than restrictive. Alternative aspects will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings, which form a part hereof wherein like numerals designate like parts throughout, and in which is shown, by way of illustration, aspects that may be practiced. It is to be understood that other aspects may be utilized and structural or logical changes may be made without departing from the scope of the present disclosure. Therefore, the preceding detailed description is not to be taken in the limiting sense, and the scope of aspects is defined by the appended claims and their equivalents.

What is claimed is:

1. One or more computer-readable media having computer-executable instructions embodied thereon that, when executed, perform a method of dynamically adjusting an application demand profile during slice fallback, the method comprising:
based on a user equipment (UE) fallback, receiving an attribute quality table for an application of the UE; and
based on the attribute quality table, radio frequency (RF) conditions, and quality of service (QOS) capabilities, optimizing capabilities for the data connection.

2. The media of claim 1, wherein the attribute quality table for the application determines a demand profile for a 5G Standalone (SA) network.

3. The media of claim 2, further comprising, based on the UE reconnecting to the 5G SA network, allocating a network slice to the application of the UE based on the demand profile.

4. The media of claim 2, further comprising receiving a real-time adjustment to the demand profile for the application in accordance with the optimized capabilities.

5. The media of claim 1, further comprising, initiating the UE fallback from a 5G Standalone (SA) network to a 5G Non-standalone (NSA) network.

6. The media of claim 1, further comprising, initiating the UE fallback from a 5G Standalone (SA) network to an evolved packet core (EPC) of a Long Term Evolution (LTE) network.

7. The media of claim 1, wherein attributes of the attribute quality table comprise one or more of: bitrate, codec, resolution, framerate, packet loss, jitter, or latency.

8. A method of dynamically adjusting an application demand profile during slice fallback, the method comprising:
based on a user equipment (UE) fallback, receiving an attribute quality table for an application of the UE; and
based on the attribute quality table, radio frequency (RF) conditions, and quality of service (QOS) capabilities, optimizing capabilities for the data connection.

9. The method of claim 8, wherein the attribute quality table for the application determines a demand profile for a 5G Standalone (SA) network.

10. The method of claim 9, further comprising, based on the UE reconnecting to the 5G SA network, allocating a network slice to the application of the UE based on the demand profile.

11. The method of claim 9, further comprising receiving a real-time adjustment to the demand profile for the application in accordance with the optimized capabilities.

12. The method of claim 8, further comprising, initiating the UE fallback from a 5G Standalone (SA) network to a 5G Non-standalone (NSA) network.

13. The method of claim 8, further comprising, initiating the UE fallback from a 5G Standalone (SA) network to an evolved packet core (EPC) of an a Long Term Evolution (LTE) network.

14. The method of claim 8, wherein attributes of the attribute quality table comprise one or more of: bitrate, codec, resolution, framerate, packet loss, jitter, or latency.

15. A system for dynamically adjusting an application demand profile during slice fallback, the system comprising:
at least one wireless base station coupled to an operator core network, wherein the at least one wireless base station establishes one or more communication links between the operator core network and a user equipment (UE);
one or more processors to perform one or more operations to:
based on the operator core network initiating a fallback, receiving an attribute quality table for an application of the UE; and
based on the attribute quality table, radio frequency (RF) conditions, and quality of service (QOS) capabilities, optimizing capabilities for a communication link of the one or more communication links.

16. The system of claim 15, wherein the attribute quality table for the application determines a demand profile for a 5G Standalone (SA) communication link.

17. The system of claim 16, further comprising, based on the UE reconnecting to the 5G SA network, allocating a network slice to the application of the UE based on the demand profile.

18. The system of claim 16, further comprising receiving a real-time adjustment to the demand profile for the application in accordance with the optimized capabilities.

19. The system of claim 15, further comprising initiating the UE fallback from a 5G Standalone (SA) communication link to a 5G Non-standalone (NSA) communication link or from the 5G SA communication link to an evolved packet core (EPC) of a Long Term Evolution (LTE) communication link.

20. The system of claim 15, wherein attributes of the attribute quality table comprise one or more of: bitrate, codec, resolution, framerate, packet loss, jitter, or latency.
